(19) United States
(12) Patent Application Publication
(10) Pub. No.: US 2011/0151883 A1
(43) Pub. Date: Jun. 23, 2011

(54) METHOD FOR COMMUNICATING IN A NETWORK, A SECONDARY STATION AND A SYSTEM THEREFOR

(75) Inventors: Gildas Bossard, Paris (FR); Timothy James Moulsley, Caterham (GB); Matthew Peter John Baker, Canterbury (GB)

(73) Assignee: Koninklijke Philips Electronics N.V., Eindhoven (NL)

(21) Appl. No.: 13/058,572

(22) PCT Filed: Aug. 7, 2009
(86) PCT No.: PCT/IB2009/053474

§ 371 Date: Feb. 11, 2011

(30) Foreign Application Priority Data
Aug. 14, 2008 (EP) 08305478.3

(51) Int. Cl. H04W 72/04

(52) U.S. Cl. 455/450

(57) ABSTRACT

The present invention relates to a method for communicating in a network, comprising a) a secondary station preparing the transmission to a primary station of a message comprising a report and a data field for containing data in an allocated resource, and b) the secondary station setting at least one transmission parameter of the message at a first level of reliability if the size of the allocated resource is bigger than the size of the message, and else setting at least one transmission parameter at second level of reliability being lower than the first level of reliability, c) the secondary station transmitting the message to the primary station.

### FIELD OF THE INVENTION

The present invention relates to a method for communicating in a network comprising a primary station and at least one secondary station, and to such a secondary station. More specifically, this invention relates to a method for communicating in a mobile telecommunication network, like a GSM (Global System for Mobile communications) or a UMTS (Universal Mobile Telecommunications System) network.

This invention is, for example, relevant for UMTS and UMTS Long Term Evolution, but as well to hubs which route calls from multiple terminals to base stations.

### BACKGROUND OF THE INVENTION

In a mobile telecommunication network like a UMTS system, a primary station, for instance a Node B (or Base Station or eNB) communicates with at least one secondary station, for instance a User Equipment (or Mobile Station), by means of a plurality of channels. In order to transmit data to the primary station, a secondary station needs to request a resource to the primary station, which is then allocated. This request of allocation of a resource for UL (Uplink) transmission can be made in several ways depending on the considered channel.

In an example, in order to request a resource, it is required to indicate the amount of data to be transmitted, i.e. the data in the buffer of the secondary station. To this end, the secondary station transmits to the primary station a BSR (buffer status report) indicative of the amount of data in the secondary station buffer. Thus, the primary station allocates a resource corresponding to both the capability of the network and the amount of data to be transmitted. This permits the allocation of resource to be adjusted.

In order to transmit this Report, the secondary station uses for instance an ARQ protocol, or an HARQ protocol. It means that the secondary station may retransmit the message until it receives a positive acknowledgement of reception from the primary station. In such a case, it is possible that a first buffer status report is finally correctly received long after having been transmitted, and in some cases even after a reception of a second report intended to update the first report. In such a case, the primary station may discard the second report believing that the first report is representative of the current status. This can lead to a waste of resources (if the second report indicated that no data was in the buffer), or in delays (if the first report indicated that no data was in the buffer).

The allocation of UL resources is made by means of a control channel transmitted in the DL (Downlink). If the UE receives the control channel incorrectly or decodes a control channel when none was transmitted, the UE will act as if it had received a grant of UL resources and, for example, transmit in the UL. Since this transmission is likely to be on a resource where the eNB is not expect a transmission from that UE, this is likely to result in interference to other UL transmissions.

Similar control channel messages are used to indicate the presence of a DL transmission to a UE. There is a possibility that such message may be falsely or incorrectly received by a UE. This can cause problems (e.g. ACK/NACK responses being transmitted on the wrong UL resource), but these are likely to be less severe than for false UL grants.

### SUMMARY OF THE INVENTION

It is an object of the invention to propose a method enabling this problem of delayed reception of buffer status reports to be alleviated.

It is still another object of the invention to propose a method improving the management of Buffer Status Reports at the primary station.

It is still another object of the invention to propose a method permitting the risk of confusion of ordering of BSRs at the primary station to be reduced.

To this end, a method of communicating in a network is proposed, comprising

a) a secondary station preparing the transmission to a primary station of a message comprising a report and a data field for containing data in an allocated resource, and
b) the secondary station setting at least one transmission parameter of the message to correspond to a first level of reliability if the size of the allocated resource is bigger than the size of the message, and else setting at least one transmission parameter to correspond to a second level of reliability being lower than the first level of reliability,
c) the secondary station transmitting the message to the primary station.

In accordance with a second aspect of the invention, a secondary station is proposed, said secondary station comprising a controller for preparing the transmission to a primary station of a message comprising a report and a data field for containing data in an allocated resource, and the controller being arranged for setting at least one transmission parameter of the message to correspond to a first level of reliability if the size of the allocated resource is bigger than the size of the message, and else setting at least one transmission parameter to correspond to second level of reliability being lower than the first level of reliability, and means for transmitting the message to the primary station.

A primary station comprising means for communicating with a secondary station, said means comprising a receiver for receiving a message from the secondary station, a decoder for decoding the message with a channel coding corresponding to the second level of reliability, and a controller for selecting one channel coding from the set of channel codings if decoding fails.

In accordance with a third aspect of the invention, a system of communication is proposed, said system comprising a primary station and at least one secondary station comprising a controller for preparing the transmission to a primary station of a message comprising a report and a data field for containing data in an allocated resource, and the controller being arranged for setting at least one transmission parameter of the message to correspond to a first level of reliability if the size of the allocated resource is bigger than the size of the message, and else setting at least one transmission parameter to correspond to a second level of reliability being lower than the first level of reliability, and means for transmitting the message to the primary station.

In accordance with a fourth aspect of the invention, a primary station is proposed, said primary station primary station comprising means for communicating with a secondary station, said means comprising a receiver for receiving a message from the secondary station, a decoder for decoding the message with a channel coding corresponding to the second level of reliability, and a controller for selecting one channel coding from the set of channel codings if decoding fails.

As a consequence, the transmission of the BSR may be improved, especially in the case where no data or a low amount of data is in the buffer. This has for consequence that the probability of this message to be lost is lower, and the probability of having this message transmitted at the first time is increased. Because of this, the messages indicating that no data is in the buffer are likely to be transmitted more quickly than the other messages. Thus, this permits a reduction in the risk of removing a potentially allocated resource due to the confusion of ordering of BSRs the primary station.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram of a system in which is implemented the invention.

FIG. 2 is a time chart illustrating the exchange of messages in accordance with a conventional technique.

### DETAILED DESCRIPTION OF THE INVENTION

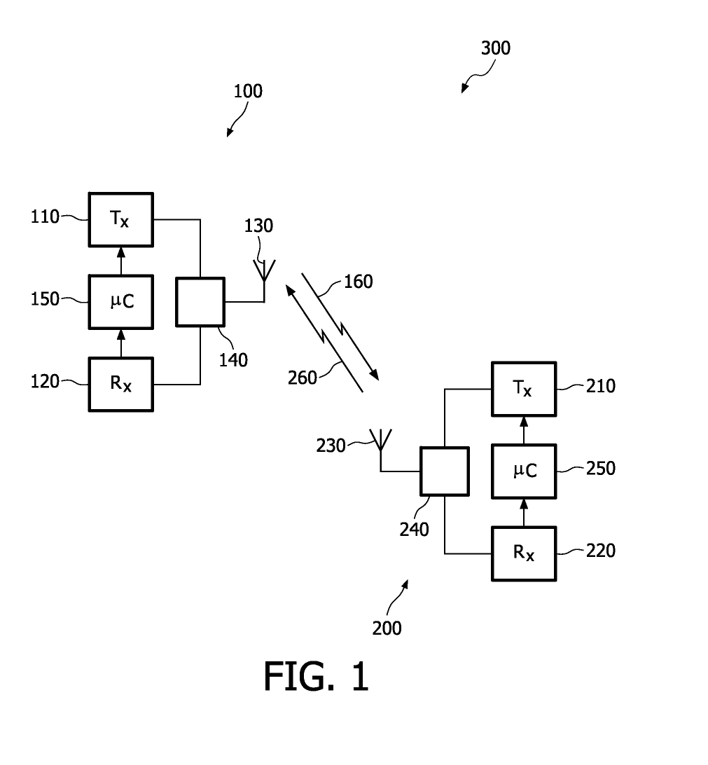

The present invention relates to a system of communication 300 as depicted on FIG. 1, comprising a primary station 100, like a base station, and at least one secondary station 200 like a mobile station.

The radio system 300 may comprise a plurality of the primary stations 100 and/or a plurality of secondary stations 200. The primary station 100 comprises a transmitter means 110 and a receiving means 120. An output of the transmitter means 110 and an input of the receiving means 120 are coupled to an antenna 130 by a coupling means 140, which may be for example a circulator or a changeover switch. Coupled to the transmitter means 110 and receiving means 120 is a control means 150, which may be for example a processor. The secondary station 200 comprises a transmitter means 210 and a receiving means 220. An output of the transmitter means 210 and an input of the receiving means 220 are coupled to an antenna 230 by a coupling means 240, which may be for example a circulator or a changeover switch. Coupled to the transmitter means 210 and receiving means 220 is a control means 250, which may be for example a processor. Transmission from the primary radio station 100 to the secondary station 200 takes place on a downlink channel 160 and transmission from the secondary radio station 200 to the first radio station 100 takes place on an uplink channel 260.

From time to time, the secondary station 200 transmits on the uplink channel 260 an indication of the status of its buffer containing data to be transmitted. This Buffer Status Report can be of different types. A short Buffer Status Report (BSR) comprises the identity of a single group of logical channels, together with a 6-bit indicator of the amount of data corresponding to that group of logical channels currently residing in the secondary station's buffer awaiting transmission. A long BSR comprises 4 concatenated short BSRs, each corresponding to a different group of logical channels.

Many communication systems operate using a centralised scheduler which is responsible for allocating transmission resources to different nodes. A typical example is the uplink of the UMTS LTE, where the uplink transmissions from different UEs are scheduled in time and frequency by the eNB; the eNB transmits a “scheduling grant” message to a UE, indicating a particular time-frequency resource for the UE's transmission typically around 3 ms after the transmission of the grant message. The grant message also typically specifies the data rate and/or power to be used for the UE's transmission.

In order for the eNB to issue appropriate grants, it needs to have sufficient information about the amount, type of data and the urgency of it awaiting transmission in the buffer of each UE. This information can be used to inform the scheduler in the eNB of either the satisfaction level of individual UEs or UEs whose service might be close to being dropped.

In LTE, a number of different types of buffer status report (BSR) messages are therefore defined, which may be transmitted from a UE to the eNB when certain triggers occur. The state of the art in this respect is defined by the current version of 3GPP TS36.321 (as of June 2008), §5.4.5 incorporated for reference.

A short BSR comprises the identity of a single group of logical channels, together with a 6-bit indicator of the amount of data corresponding to that group of logical channels currently residing in the UE's buffer awaiting transmission. A long BSR comprises 4 concatenated short BSRs, each corresponding to a different group of logical channels.

This is currently defined in 36.321 (as of June 2008) §6.1.3.1 incorporated by reference.

As detailed in this paragraph, there are two main types of Buffer Status Reports (BSR) with different characteristics:
Regular BSR which is triggered only if UL data arrives in the UE transmission buffer and the data belongs to a logical channel with higher priority than those for which data already existed in the UE transmission buffer.
Periodic BSR, which is triggered when the PERIODIC BSR TIMER expires. If the UE has no UL resources allocated for new transmission for this TTI and if a Regular BSR has been triggered since the last transmission of a BSR a Scheduling Request (SR) shall be triggered.

The BSR mechanism has been designed so that only regular BSRs can trigger the sending of an SR if there is no UL resources available for the sending of the a regular BSR. When a periodic BSR is triggered and there is no UL resource allocated then the UE cannot send SR, as it is assumed that the network knows that the UE has data available and is deliberately not allocating any UL resources for the UE to use.

If the periodic BSR were allowed to send SR in the case of no UL resource available for the sending of the BSR then the system may become overloaded with UEs sending SR. Particularly if the UE has no PUCCH resources available, when an SR would require the sending of a RACH access.

Also, it is stated in 36.321 that an SR is considered pending and is repeated until UL-SCH resources are granted.

A problem with the BSR procedure defined above is that there is a possibility that the information that the network knows about the state of the buffers in the UE can be different from the actual state of the UE buffers. This can occur when BSRs are received in the eNB out of order.

If a network receives BSRs from a UE at different times there is no way for the eNB to determine which was the last BSR sent by the UE as an earlier BSR may just be being received late, for example due to HARQ retransmissions. This can lead to the problem that a BSR with zero may be received by the UE and then the network removes UL resource from the UE, even though the UE now has data to be sent in its buffer. The UE cannot send SR as the trigger for a regular BSR (new data with higher priority) is not met even if a periodic BSR is configured

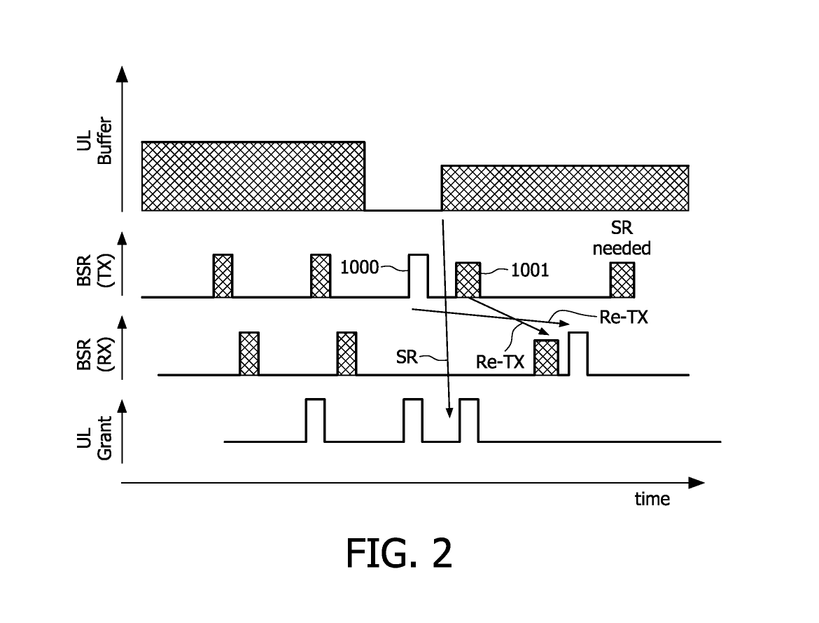

An example of this is shown on FIG. 2. On this time chart, it can be seen that the buffer status report 1000, which is sent before the buffer status report 1001, is received only after, because of the number of retransmissions. This report 1000 may be a periodic report, which can indicate that no data is in the buffer status report. If the primary station receives the reports in the indicated order, it will wrongly believe that the current status is that no data is in the buffer of the secondary station. Because of that, it will remove the UL resource from UE, that should have been granted.

If the report 1000 is a normal report indicating that there is data to be transmitted, and report 1001 a periodic report indicating that there is no more data to be transmitted, the primary station may, because of this confusion allocate a resource although it was not required. This leads to a waste of resources. However, this situation is less likely to happen.

The main problem here is that an SR cannot be generated from a periodic BSR, because if an SR were generated from a periodic BSR then the UE would be constantly asking for UL resources when there may be none available.

Moreover, in the case described above the network view of the buffer status of the UE UL data buffer is out of synchronisation with its actual status. The present invention provides a method for distinguishing the order in which the BSRs from the UE should be acted on, by means of information transmitted together with the BSR, as will be explained hereafter.

In LTE, when the secondary station has an uplink grant which is too large for the amount of data (which is the case for instance is no data is in the buffer), it will transmit anyway and add padding, including a padding BSR if possible. Padding is applied in order to reach the granted transport block size. This will occur even if there is no data to be transmitted. This situation can lead to wasted uplink resources from sending the padding bits.

Reliable reception of the BSR is important, in order to allow efficient scheduling. Therefore methods for improving BSR robustness are of interest.

In principle it would be possible to make use of the padding bits in the decoding process (provided their values are known). However, this would require changes to receiver decoding algorithms, and would not be the most efficient way of using these bits.

An aspect of the invention is based on the recognition that when a secondary station is granted more resource than is required for uplink data transmission plus other signalling such as BSR, it may use the additional resource to transmit additional redundancy, rather than padding bits. This can increase the probability of correct decoding of the BSR message. The main disadvantage of this aspect of the invention is that the primary station or eNodeB may have additional processing. For example, if reception of an uplink packet fails, the eNodeB may need to also attempt decoding under the assumption that a padding BSR (or other message of known size) has been sent instead. This would require additional soft buffers to be maintained. Fortunately the extra processing load will typically be small, since the transport block size will not be large for a BSR sent with no data. A similar disadvantage applies in any case where the UE may transmit in more than one format for the same granted UL resources.

In one embodiment based on LTE, when a secondary station receives an UL grant (indicating a resource and a transport block size) but has no data to send, it transmits a padding BSR. According to the invention the transport block size is reduced to a value which is just sufficient to send the BSR message. Then channel coding is applied in the usual way, and this will add redundancy up to the transport block size. The eNodeB can attempt to decode the resulting message first under the assumption of a normal transmission, then if that fails, under the assumption that BSR was sent with a smaller transport block (but with one of a limited set of sizes).

In another embodiment based on LTE, when a secondary station receives an uplink grant (indicating a resource and a transport block size) but has less data to send than indicated in the grant, then according to the invention it assumes a reduced transport block size (which may be chosen from a limited set), and transmits a padding BSR and data. The channel coding is applied in the usual way for that selected transport block size. As a consequence, the channel coding may typically be of a lower rate than the coding corresponding to the block of a normal size. The eNodeB can attempt to decode the resulting message first under the assumption of a normal transmission, then if that fails, under the assumption that BSR was sent with a smaller transport block size (but with one of a limited set of sizes) and its corresponding coding. In a variant of this embodiment, only one coding is associated to each size of transport block.

In another embodiment based on LTE, when a UE receives an UL grant (indicating a resource and a transport block size) but has less data to send than indicated in the grant, the transport block size is not changed, but the message is repeated inside the transport block to increase its size to be equal to the granted transport block size. Channel coding is applied in the usual way. This means that the padding bits are effectively replaced by data repetition. This has the disadvantage of requiring a change to the receiver decoding architecture, in order to exploit the data repetition efficiently.

In a variant of the invention, this invention could be used in combination with one of the following embodiments.

The following embodiments are based on the recognition that the UE does not need to transmit using the whole granted resource in the case that it has no data, but there is some other small message to send. For example, in the case that a UE should transmit some small message, such as BSR, even when it has no data to send along with this Buffer Status Report, then it is proposed that UE transmits with a limited resource (and a reduced transport block size). To ensure that the eNodeB is aware of the resulting message size and resources used, these should ideally be derived from the granted resource. For instance, if the granted resource is n resource blocks, the size of the utilized resource could be 0.25 n blocks.

In the case that the secondary station really is granted a resource, but has no data, then it can still send a BSR or other message. In the case of a false detection of an UL grant the UL interference will typically be much lower than if the UE used the full granted resource.

This can be combined with the previous embodiments for instance as follows in the next example. A secondary station is granted 8 resource blocks although one resource blocks would be sufficient to transmit the Buffer Status Report, and no data is to be transmitted. It is thus proposed to send this BSR with two resource blocks, and a corresponding coding. Then, the secondary station will prevent itself from transmitting during the 6 remaining resource blocks. The main disadvantage of this embodiment is that the eNodeB may have additional processing. For example, if reception of a secondary station packet fails, the eNodeB may need to also attempt decoding under the assumption that a BSR is sent with no data in the smaller resource. This would require additional soft buffers to be maintained. Fortunately the extra processing load will be small, since the transport block size will not be large for a BSR sent with no other data.

In a variant of this embodiment based on LTE, if a secondary station receives a grant for UL transmission, but has not data to send, the specification requires it to send a BSR. The BSR is sent in a resource derived from the grant message. As an example this could be defined to be the single lowest frequency Resource Block (RB) within the set of Resource Blocks in the granted resource. The transport block size is fixed to be the smallest size which can contain the BSR (and any associated overheads).

In various examples of applications of the invention, not restricted to UMTS or LTE, the resources could be frequency domain resource blocks, time slots or codes. These embodiments of the invention could also be applied to other messages. One main requirement to reduce the processing load of the primary station is that the message size is known or can be deduced. Then, the primary station will be able to perform an additional decoding assuming the message size (and resource allocation). As a consequence, support of a small set of allowed message sizes would be possible.

These embodiments could also be applied in the case that the secondary station has data to transmit but the resource is much too large for the data packet, in which case a smaller resource could be used instead (e.g. half the granted resource). In general, this approach would lead to a small number of additional resource sizes (and transport block sizes) which would be allowed in response to each UL grant. The eNodeB might thus be required to perform more than one decoding attempt for each packet, under different assumptions about its size. But as explained above, this could be done with a small set of transport block sizes.

This invention and its various embodiments may be implemented in mobile communication systems where communication devices utilize centralized scheduling, such as UMTS and LTE.

Moreover, this invention could as well be implemented for hubs which route connections from multiple terminals to base stations. Such devices would appear like a secondary station from the point of view of the network.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communication and the art of transmitter power control and which may be used instead of or in addition to features already described herein.

1. A method for communicating in a network, comprising
a) a secondary station preparing the transmission to a primary station of a message comprising a report and a data field for containing data in an allocated resource, and
b) the secondary station setting at least one transmission parameter of the message to correspond to a first level of reliability if the size of the allocated resource is bigger than required for the size of the message, or else setting at least one transmission parameter to correspond to a second level of reliability being lower than the first level of reliability,
c) the secondary station transmitting the message to the primary station.

2. The method of claim 1, wherein the report is indicative of the amount of data in a buffer of the secondary station.

3. The method of claim 2, wherein step b) further comprises the secondary station setting at least one transmission parameter of the message to correspond to the first level of reliability if the report indicates that no data is in the buffer of the secondary station.

4. The method of claim 1, wherein setting the transmission parameter of the message to correspond to the first level of reliability comprises using at least one unused bit of the data field for increasing the reliability of the message.

5. The method of claim 4, wherein setting the transmission parameter of the message to correspond to the first level of reliability comprises repeating one or more message bits up to the size of the allocated resource.

6. The method of claim 1, wherein setting the transmission parameter of the message to correspond to the first level of reliability the at least one transmission parameter comprises selecting a message size being smaller than the allocated resource size, and selecting a channel coding dependent on the selected message size and the allocated resource size.

7. The method of claim 1 wherein setting the transmission parameter of the message to correspond to the first level of reliability the at least one transmission parameter comprises selecting a transmitted resource size being smaller than the allocated resource size, and selecting a channel coding dependent on the selected message size and the selected resource size.

8. The method of claim 6 wherein the message size and the channel coding are selected from a set of predetermined message sizes and channel codings.

9. The method of claim 8, further comprising d) the primary station receiving the message, e) decoding the message with a channel coding corresponding to the second level of reliability and f) if decoding fails, selecting one channel coding from the set of channel codings, and decoding the message with this selected channel coding.

10. The method of claim 8, further comprising d) the primary station receiving the message, e) decoding the message with a channel coding corresponding to the second level of reliability and f) if decoding fails, selecting one message size from the set of message sizes and decoding the message with this selected message size.

11. The method of claim 1 wherein the at least one transmission parameters comprises a transmission power.

12. A secondary station comprising a controller for preparing the transmission to a primary station of a message comprising a report and a data field for containing data in an allocated resource, and the controller being arranged for setting at least one transmission parameter of the message to correspond to a first level of reliability if the size of the allocated resource is bigger than the size of the message, and else setting at least one transmission parameter to correspond to a second level of reliability being lower than the first level of reliability, and means for transmitting the message to the primary station.

13. A system comprising a primary station and at least one secondary station comprising a controller for preparing the transmission to a primary station of a message comprising a report and a data field for containing data in an allocated resource, and the controller being arranged for setting at least one transmission parameter of the message to correspond to a first level of reliability if the size of the allocated resource is bigger than the size of the message, and else setting at least one transmission parameter to correspond to a second level of reliability being lower than the first level of reliability, and means for transmitting the message to the primary station.

14. A primary station comprising means for communicating with a secondary station, said means comprising a receiver for receiving a message from the secondary station, a decoder for decoding the message with a channel coding corresponding to the second level of reliability, and a controller for selecting one channel coding from the set of channel codings if decoding fails.
